(19) United States
(12) Patent Application Publication
(10) Pub. No.: US 2019/0212838 A1
(43) Pub. Date: Jul. 11, 2019

(54) PEN-TYPE HAPTIC FORCE DELIVERY DEVICE

(71) Applicant: NIDEC SANKYO CORPORATION, Nagano (JP)

(72) Inventors: Tadashi TAKEDA, Nagano (JP); Hiroshi KITAHARA, Nagano (JP); Masao TSUCHIHASHI, Nagano (JP)

(21) Appl. No.: 16/323,857

(22) PCT Filed: Aug. 3, 2017
(86) PCT No.: PCT/JP2017/028224

§ 371 Date: Feb. 7, 2019

(30) Foreign Application Priority Data
Aug. 9, 2016 (JP) 2016-156895

(51) Int. Cl. G06F 3/0354; G06F 3/01; G08B 6/00

(52) U.S. Cl. CPC G06F 3/03545; G08B 6/00; G06F 3/016

(57) ABSTRACT

A pen-type haptic force delivery device that causes a user to perceive haptic force information may include a case having a shaft portion which the user holds by hand; and a vibration generating device provided inside of the case. The vibration generating device may include a movable body, a support body, an elastic member having either elasticity or viscoelasticity, the elastic member being arranged between the movable body and the support body, and a magnetic drive circuit structured to cause linear vibrations to the movable body to output the haptic force information.

### CROSS REFERENCE TO RELATED APPLICATIONS

This is the U.S. national stage of application No. PCT/JP2017/028224, filed on Aug. 3, 2017. Priority under 35 U.S.C. § 119(a) and 35 U.S.C. § 365(b) is claimed from Japanese Application No. 2016-156895, filed Aug. 9, 2016; the disclosures of which are incorporated herein by reference.

### FIELD OF TECHNOLOGY

At least an embodiment of the present invention relates to a pen-type haptic force delivery device that causes a user holding the pen in his hand to perceive haptic force information.

### BACKGROUND

A haptic force information delivery system has been proposed in which haptic force information is output to a user through movements of an eccentric rotor; proposed as its example is a pen-type haptic force delivery device that outputs haptic force information from a pen-type laser pointer (Patent reference 1). When a user uses a laser pointer, this system causes the user to perceive a resistance force against the pointer.

Patent reference 1: Unexamined Japanese Patent Application 2005-190465 Publication

A haptic force information delivery system is anticipated to be used in fields of education, support for the visually impaired, virtual reality, amusement and the like. However, if an eccentric rotor is driven to rotate by a motor in a configuration of a hand-held device such as a pen-type haptic information delivery system as in a system disclosed in Patent reference 1, the weight of the pen-type haptic force information delivery device will be increased. Also, in the configuration in which an eccentric rotor is rotated by a motor, the cost of the pen-type haptic force information delivery device will be increased.

### SUMMARY

Considering the above problems, at least an embodiment of the present invention is devised to provide a pen-type haptic force information delivery system that can reduce cost and weight.

To achieve the above, at least an embodiment of the present invention is a pen-type haptic force delivery device that causes a user to perceive haptic force information, comprising a case provided with a shaft portion for a user to hold by hand and a vibration generating device which is provided inside of the case; wherein the vibration generating device is equipped with a movable body, a support body, an elastic member which has either elasticity or viscoelasticity and is arranged between the movable body and the support body, and a magnetic drive circuit which causes the movable body to linearly vibrate and outputs haptic force information.

In at least an embodiment of the present invention, the movable body supported to the support body by the elastic member is caused to vibrate linearly by the magnetic drive circuit and outputs haptic force information to a user; therefore, vibrations having a directionality (the haptic force information) can effectively be generated in a relatively simple configuration [of the device]. Therefore, the cost and weight of the pen-type haptic force delivery device can be reduced.

In at least an embodiment of the present invention, the vibration generating device may adopt a configuration having either a first vibration generating device, which outputs linear vibrations in the direction crossing the axial direction of the shaft portion as haptic force information, or a second vibration generating device, which outputs linear vibrations in the axial direction as haptic force information. In at least an embodiment of the present invention, the configuration that includes both the first vibration generating device and the second vibration generating device may be adopted. In that case, in a relatively simple configuration [of the device], the linear vibrations in the direction crossing the axial direction, the linear vibrations in the axial direction and the vibrations made up of those vibrations can be output as the haptic force information.

At least an embodiment of the present invention may adopt a configuration in which at least the first vibration generating device is provided as the vibration generating device, and in which the first vibration generating device outputs the linear vibrations in the first direction, which intersects with the axial direction, as the haptic force information and outputs the linear vibrations in the second direction, which intersects with the axial direction and the first direction, as haptic force information. According to this configuration, the linear vibrations in the axial direction of the shaft portion, the linear vibrations in the first direction, the linear vibrations in the second direction and the vibrations made up of those vibrations can be output as haptic force information with a relatively simple configuration [of the device].

In at least an embodiment of the present invention, at least the second vibration generating device be used as the vibration generating device and that in that case, a sound-emitting hole be created to discharge the pressure change, which is caused by the vibrations in the axial direction of the second vibration generating device, as an audible sound. According to this configuration, the information can be output as a sound, in addition to the haptic force information.

In at least an embodiment of the present invention, the movable body supported to the support body by the elastic member is vibrated linearly by the magnetic drive circuit to output haptic force information to a user; therefore, the vibrations having a directionality (the haptic force information) can efficiently be generated with the relatively simple configuration [of the device]. Therefore, the cost and weight of the pen-type haptic force delivery device can be reduced.

### BRIEF DESCRIPTION OF DRAWING

Embodiments will now be described, by way of example only, with reference to the accompanying drawings which are meant to be exemplary, not limiting, and wherein like elements are numbered alike in several Figures, in which:

FIG. 1 is an explanatory drawing of a pen-type haptic force delivery device to which at least an embodiment of the present invention is applied.

FIG. 2 is a perspective view of a first vibration generating device used in the pen-type haptic force delivery device to which at least an embodiment of the present invention is applied.

FIGS. 3A and 3B are cross-sectional views of the first vibration generating device of FIG. 2.

FIG. 4 is a perspective view of the exploded first vibration generating device of FIG. 2.

FIG. 5 is a perspective view of an exploded major part of the first vibration generating device of FIG. 2.

FIG. 6 is a perspective view of the exploded major part of the first vibration generating device of FIG. 2, in which some magnets and coils are removed from the movable body and the support body.

FIGS. 7A and 7B are perspective views of a second vibration generating device used in a pen-type haptic force delivery device to which at least an embodiment of the present invention is applied.

FIGS. 8A and 8B are cross-sectional views of the second vibration generating device of FIG. 7.

FIG. 9 is a perspective view of the exploded second vibration generating device of FIG. 2, in which the support member is removed.

FIG. 10 is a perspective view of the second vibration generating device shown in FIG. 7 in the state in which members arranged inside of the support member are exploded.

FIGS. 11A and 11B are perspective views of the exploded second vibration generating device shown in FIG. 7 in the state in which an outer yoke is removed from the outer side of a coil.

FIG. 12 is a perspective view of the exploded second vibration generating device shown in FIG. 7 in the state in which a permanent magnet, etc. are removed from the inner side of the coil.

### DETAILED DESCRIPTION

At least an embodiment of the present invention is described referring to the drawings. Note that, in the description below, a first direction L1 is the direction crossing the axial direction of a shaft portion 111 of a pen-type haptic force delivery device 100; a second direction L2 is the direction which crosses the axial direction of the shaft portion 111 and the first direction L1; a third direction L3 is the axial direction of the shaft portion 111. One side of the first direction L1 is given a code L1a, the other side of the first direction L1 is given a code L1b, one side of the second direction L2 is given a code L2a, the other side of the second direction L2 is given a code L2b, one side of the third direction L3 is given a code L3a and the other side of the third direction L3 is given a code L3b. For the purpose of clarifying the layout of members in the description of the configuration of a first vibration generating device 1a, the directions which cross each other are indicated as an X axis direction, a Y axis direction and a Z axis direction. The first direction L1 extends along the X axis direction; the second direction L2 extends along the Y axis direction; the third direction L3 extends along the Z axis direction.

[Configuration of Pen-Type Haptic Force Delivery Device]

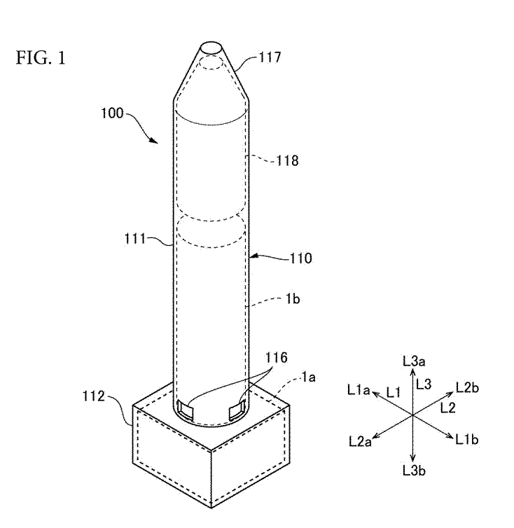

FIG. 1 is an explanatory drawing of a pen-type haptic force delivery device to which at least an embodiment of the present invention is applied. FIG. 1 shows that the pen-type haptic force delivery device 100 has a case 110 having a shaft 111 for a user to hold by hand, and a first vibration generating device 1a and a second vibration generating device 1b are arranged inside of the case 110. The pen-type haptic force delivery device 100 causes a user to perceive vibrations generated by the first vibration generating device 1a and the second vibration generating device 1b via the case 110. The case 110 has a base portion 112, which has a larger outside diameter than that of the shaft portion 111, at the end portion on the other side L3b of the shaft portion 111 of the first direction.

The first vibration generating device 1a is arranged inside of the base portion 112 and outputs linear vibrations in the direction crossing the third direction L3 as haptic force information. In this embodiment, the first vibration generating device 1a outputs linear vibrations in the first direction L1 as haptic force information as well as linear vibrations in the second direction L2 as haptic force information. The second vibration generating device 1b is arranged inside of the shaft portion 111 and outputs linear vibrations in the axial direction of the shaft portion 111 (the third direction L3) as haptic force information.

In the case 110, a sound-emitting hole 116 is provided at the base side of the shaft portion 111 to emit the pressure changes, which accompany the vibrations in the third direction L3 at the second vibration generating device 1b, as an audible sound. A tip portion 117 of the shaft portion 111 (the end portion on one side L3a in the third direction) is formed in a truncated cone shape, of which the tip end is drawn, and the pen-type haptic force delivery device 100 is constructed as an input pen used to input coordinates, etc. on a screen of a flat display (no illustration) used for a haptic force information delivery system. Therefore, inside the tip portion 117 of the shaft portion 111, a signal output portion 18 is built in to output optical signals or magnetic signals to the flat display.

[Configuration of First Vibration Generating Device 1a]

### (Overall Configuration of First Vibration Generating Device 1a)

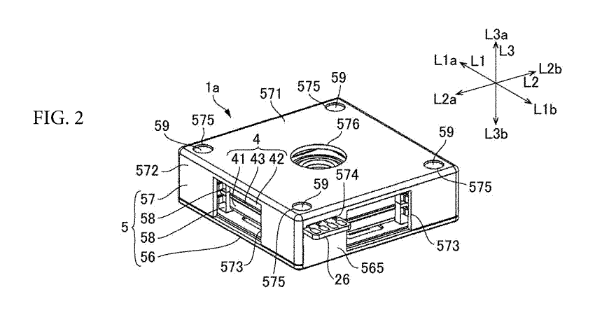

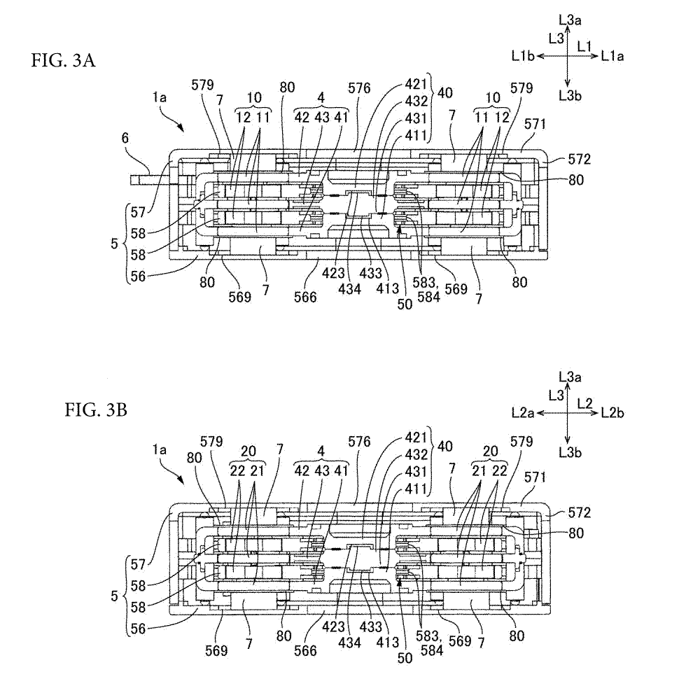

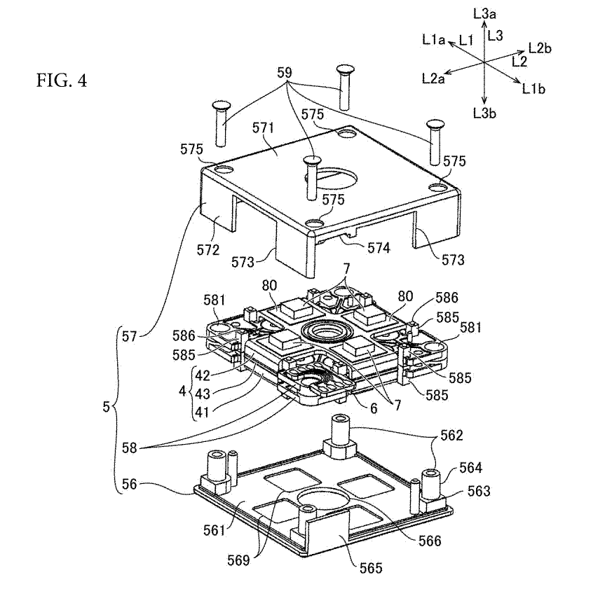

FIG. 2 is a perspective view of the first vibration generating device 1a used in the pen-type haptic force delivery device 100 to which at least an embodiment of the present invention is applied. FIG. 3 is cross-sectional views of the first vibration generating device 1a shown in FIG. 2: FIGS. 3A and 3B are respectively an XZ cross-sectional view taken along the line passing through the center portion of the first vibration generating device 1a, and a YZ cross-sectional view taken along the line passing through the center portion of the first vibration generating device 1a. FIG. 4 is a perspective view of the exploded first vibration generating device 1a shown in FIG. 2.

As shown in FIG. 2, FIG. 3 and FIG. 4, the first vibration generating device 1a has a movable body 4, a support body 5, an elastic member 7 arranged between the movable body 4 and the support body 5 and magnetic drive circuits (a first magnetic drive circuit 10 and a second magnetic drive circuit 20) which vibrate the movable body 4 linearly and outputs [the linear vibrations] as haptic force information; the support body 5 is supported to the case 110 shown in FIG. 1. The elastic member 7 has either elasticity or viscoelasticity, and the support body 5 supports the movable body 4 via the elastic member 7 in the first direction L1 and the second direction L2.

The first magnetic drive circuit 10 has a first coil 12 held by the support body 5 and a first magnet 11 held by the movable body 4; the first magnet 11 and the first coil 12 are opposed to each other in the third direction L3. The second magnetic drive circuit 20 has a second coil 22 held by the support body 5 and a second magnet 21 held by the movable body 4, and the second magnet 21 and the second coil 22 are opposed to each other in the third direction L3. The first direction L1 in which the first magnetic drive circuit 10 generates a drive force is the X-axis direction; the second direction L2 in which the second magnetic drive circuit 20 generates a drive force is the Y-axis direction. The first magnet 11 and the first coil 12 are respectively placed at two positions which are spaced in the first direction L1. The second magnet 21 and the second coil 22 are respectively placed at two positions which are spaced in the second direction L2.

(Configuration of Support Body 5)

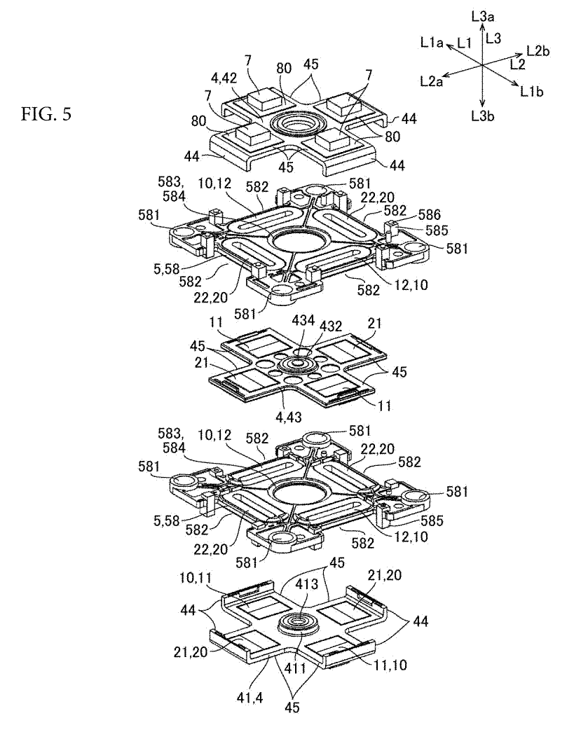

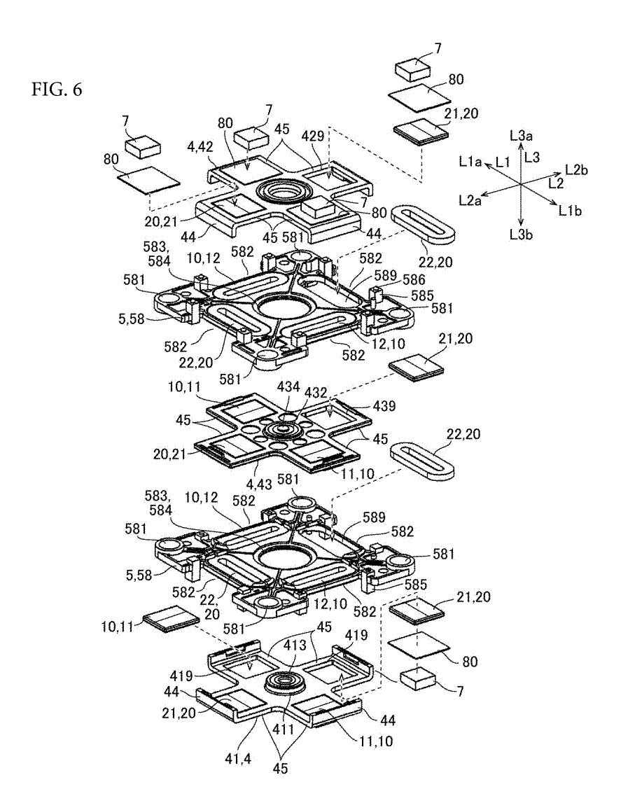

FIG. 5 is a perspective view of an exploded major portion of the first vibration generating device 1a shown in FIG. 2. FIG. 6 is a perspective view of the exploded major portion of the first vibration generating device 1a shown in FIG. 2, in which some magnets and coils are removed from the movable body 4 and the support body 5.

The support body 5 is constructed with a first cover 56 positioned on the other side L3b in the third direction L3, a second cover 57 that covers the first cover 56 from one side L3a in the third direction, and a holder 58 (a holder on the support body side) positioned between the first cover 56 and the second cover 57; the first cover 56 and the second cover 57 are fixed together by four fixing screws 59, interposing the holder 58 between them.

The second cover 57 has an end plate 571 which is shaped in a square plane when viewed in the third direction L3, and four side plates 572, each of which protrudes from each edge of the end plate toward the first cover 56. A circular hole 576 is formed in the center of the end plate 571, and fixing holes 575 are formed at four corners. In the center portion of each of the four side plates 572, a notch portion 573 is formed by cutting the center portion [of the side plate] from the other side L3b toward one side L3a in the third direction L3. In the side plate 572 on the other side L1 in the first direction L1, a notch portion 574 is created by cutting the portion next to the notch portion 573 by a partial height in the third direction L3.

The first cover 56 has an end plate 561, which is shaped in a square plane when viewed in the third direction L3, and bosses 562 which protrude from four corners of the end plate 561 toward the end plate 571 of the second cover 57. A circular hole 566 is formed in the center of the end plate 561. Each of the bosses 562 is provided with a step surface 563 formed part of the way in the third direction L3 and a cylindrical portion 564 protruded from the step surface 563 toward one side L3a in the third direction L3. Therefore, by screwing the fixing screws 59 to the bosses 562 of the first cover 56 through the fixing holes 575 of the second cover 57 from one side L3a in the third direction, the end plate 571 of the first cover 56 is fixed to the edge on the other side L3b in the third direction L3 of the side plates 572. The first cover 56 is provided with a rising portion 565 which is to oppose the notch portion 574 of the second cover 57 in the first direction L1; the rising portion 565 configures with the notch portion 574 a slit which is used to position the base board 26. Connected to the base board 26 are a feeder [to supply power] to the first coil 12 and the second coil 22.

As shown in FIG. 3, FIG. 5 and FIG. 6, two holders 58 are layered in the third direction L3 between the first cover 56 and the second cover 57. The basic configurations of the two holders 58 are shared, and a hole 583 is formed in the center of each holder 58. In this embodiment, the hole 583 is circular. Circular holes 581 are formed at four corners of each of the two holders 58; the cylindrical portions 564 of the bosses 562 are inserted in the circular holes 581 and the holders 58 are positioned and held at the step surfaces 563. In the center of each of the four sides of the holder 58, a recess portion 582 is indented toward the inner circumference. [Two] plate members of the same configuration are inverted in the third direction L3 to configure the two holders 58. Therefore, column-like protrusions 585 protrude from the holder 58, which is arranged on the other side L3b in the third direction L3, toward the first cover 56 while multiple column-like protrusions 585 protrude from the other holder 58, arranged on one side L3a in the third direction L3, toward the second cover 57. Also, a spherical contact portion 586 is formed at a tip end of each of the multiple column-like protrusions 585.

(Arrangement of First Coil and Second Coil)

In each of the two holders 58, an elongated through hole 589 is formed at four places between the recess portions 582 and the hole 583. In each of the two holders 58, a first coil 12 of the first magnetic drive circuit 10 is held inside the two through holes 589 which are opposed in the first direction L1. Also, in each of the two holders 58, a second coil 22 of the second magnetic drive circuit 20 is held inside the two through holes 589 which are opposed in the second direction L2. Therefore, each of the two holders 58 holds the first coil and the second coil 22 in one layer in the third direction L3, and the first coil 12 and the second coil 22 are layered in the third direction in the support body 5. The first coil 12 is a flat coreless coil having a long side, which is an effective side, in the second direction L2; the second coil 22 is also a flat coreless coil having a long side, which is its effective side, extends in the first direction L1.

(Configuration of Movable Body 4)

The movable body 4 has a sheet-like first holder 41 (a holder for a movable body) which is positioned on the other side L3b in the third direction L3 of the two holders 58, a sheet-like second holder 42 (a holder for a movable body) which is positioned on one side L3b in the third direction L3 of the two holders 58, and a sheet-like third holder 43 (a holder for a movable body) which is positioned between the two holders 58. The first holder 41, the second holder 42 and the third holder 43 respectively have four protrusion portions 45 which protrude to both sides in the first direction L1 and in the second direction L2 to appear as in a +(plus) shape when viewed in the third direction L3. The tip end portion of each protrusion portion 45 formed to the first holder 41 is formed as a joint part 44 which is bent to one side L3a in the third direction L3, and the tip end portion of each protrusion portion 45 formed to the second holder 42 is formed as a joint part 44 which is bent to the other side L3b in the third direction L3. Therefore, when the first holder 41, the second holder 42 and the third holder are assembled together in layers, the tip end portion of each protrusion portion 45 of the first holder 41 contacts the tip end portion of the corresponding protrusion portion 45 of the second holder 42 and the third holder 43. By joining the corresponding tip end portions of the protrusion portions 45 of the first holder 41, the second holder 42 and the third holder 43 by a method of adhesive or welding, the first holder 41, the second holder 42 and the third holder 43 are joined together.

(Arrangement of First Magnet 11 and Second Magnet 21)

The first holder 41, the second holder 42 and the third holder 43 respectively each have a rectangular through hole 419, 429 and 439 formed in each of the four protrusion portions 45 which protrude to both sides in the first direction L1 and in the second direction L2. First magnets 11 of the first magnetic drive circuit 10 are held in the through holes 419, 429 and 439 of the two protrusion portions 45 which are opposed in the first direction L1. Also, second magnets 21 of the second magnetic drive circuit 20 are held in the through holes 419, 429 and 439 in the two protrusion portions 45 which are opposed in the second direction L2. Therefore, the first holder 41, the second holder 42 and the third holder 43 respectively hold the first magnets 11 and the second magnets 21 in one layer in the third direction L3.

As described, the multiple first coils 12 are arranged in layers in the third direction L3, and the first magnets are arranged at both sides in the third direction L3 of each of the first coils 12 of the first magnetic drive circuit 10. In this embodiment, the first coils 12 and the second coils 22 are arranged in two layers in the third direction L3, and the first magnets 11 are arranged at both sides in the third direction L3 of each of the multiple first coils 12. Also, the multiple second coils 22 are arranged in layers in the third direction L3 and the second magnets 21 are arranged at both sides in the third direction L3 of each of the multiple second coils 22 of the second magnetic drive circuit 20. In this embodiment, the first coils 12 and the second coils 22 are arranged in two layers in the third direction L3, and the second magnets 21 are arranged at both sides in the third direction L3 of each of the multiple second coils 22 in each layer. The first magnet 11 is a sheet magnet, of which the magnetizing and polarizing line extends in the second direction L2; the second magnet 21 is also a sheet magnet, of which the magnetizing and polarizing line extends in the first direction L1.

A back yoke 80 is layered on the other side L3b in the third direction L3 of each of the first magnets 11 and the second magnets 21 held in the first holder 41. Also, a back yoke 80 is layered on one side L3a in the third direction L3 of each of the first magnets 11 and the second magnets 21 held in the second holder 42. The back yoke 80 is larger than the first magnet 11 or the second magnet 21 (the size of the through hole 419, 429) in size and fixed to the first holder 41 and the second holder 42 by a method of adhesive, etc.

(Configuration of Elastic Member 7)

Between the back yoke 80 provided to the first holder 41 and the end plate portion 561 of the first cover 56, an elastic member 7 which contacts the back yoke 80 and the first cover 56 is provided at four positions [where the yokes are]. Between the back yoke 80 provided in the second holder 42 and the end plate portion 571 of the second cover 57, an elastic member 7 which contacts the back yoke 80 and the second cover 57 is provided at four positions [where the yokes are].

In this embodiment, the elastic member 7 composed of a viscoelastic body is arranged between the movable body 4 and the support body 5. Viscoelasticity has characteristics of both viscosity and elasticity, which are remarkably found in a polymer substance such as a gel-based member, a plastic, a rubber, etc. Therefore, various kinds of gel-based members can be used for the elastic member 7 (the viscoelastic body). Also, the elastic member 7 (the viscoelastic body) may use various rubber materials and their modified materials such as natural rubber, diene-based rubber (such as styrene butadiene rubber, isoprene rubber or butadiene rubber), chloroprene rubber, acrylonitrile butadiene rubber, etc.) non-diene-based rubber (such as butyl rubber, ethylene propylene rubber, ethylene propylene diene rubber, urethane rubber, silicone rubber, fluororubber, etc.) or thermoplastic elastomer, etc. In this embodiment, the elastic member 7 (the viscoelastic body) is composed of a silicone gel sheet. The planar shape of the elastic member 7 is in a polygon such as a rectangle; the portion of the end plate portion 561 of the first cover 56 and the portion of the end plate portion 571 of the second cover 57 in which the elastic members 7 are positioned are made as recess portions 569 and 579 (FIG. 3). For example, the elastic member 7 (the viscoelastic body) is composed of a silicone-based gel with penetration of 10° to 110°. Penetration is defined by JIS-K-2227 or JIS-K-2220, where the smaller the value is the harder the material is.

A gel-based damper member used for the elastic member 7 has viscoelasticity and has linear or nonlinear stretch characteristics according to its stretch direction. For example, a plate-like gel-based damper member demonstrates the stretch characteristics in which a nonlinear component is larger than a linear component when pressed and compressively deformed in its thickness direction. On the other hand, when pulled and stretched in the thickness direction, it demonstrates the stretch characteristics in which a linear component is larger than a nonlinear component. Also, when deformed in the direction (the sheering direction) crossing the thickness direction, it demonstrates the stretch characteristics in which a linear component is larger than a nonlinear component. More specifically described, the elastic member 7 (the viscoelastic body) is a gel-based damper member composed of a silicone gel, etc. In this embodiment, the elastic member 7 (the viscoelastic body) demonstrates linear or nonlinear stretch characteristics according to its stretch direction. For example, the elastic member 7 (the viscoelastic body) demonstrates the stretch characteristics in which a nonlinear component (a spring coefficient) is larger than a linear component (a spring coefficient) when pressed and compressively deformed in its thickness direction (in the axial direction). On the other hand, when pulled and stretched in the thickness direction (in the axial direction), it demonstrates the stretch characteristics in which a linear component (a spring coefficient) is larger than a nonlinear component (a spring coefficient). Because of this, when the elastic member 7 (the viscoelastic body) is pressed and compressively deformed in the thickness direction (in the axial direction) between the movable body 4 and the support body 5, it is prevented from being significantly deformed; therefore, the gap between the movable body 4 and the support body 5 is kept from fluctuating significantly. On the other hand, when the elastic member 7 (the viscoelastic body) is deformed in the direction (the sheering direction) crossing the thickness direction (the axial direction), the deformation is in the direction the elastic member 7 is pulled and stretched no matter which direction it moves; therefore, it demonstrates the deformation characteristics in which a linear component (a spring coefficient) is larger than a nonlinear component (a spring coefficient). Therefore, a spring force by a moving direction is constant in the elastic member 7 (the viscoelastic body). Therefore, by using the spring element in the sheering direction of the elastic member 7 (the viscoelastic body), the reproducibility of vibratory acceleration to the input signals can be improved, enabling it to produce vibrations with delicate nuance.

(Configuration of Stopper Mechanism 50)

As shown in FIG. 3, etc., in the center of the first holder 41, a protruded coupling portion 411 having a smaller outside diameter than the hole 583 in the holder 58 protrudes to one side L3a in the third direction; in the center of the second holder 42, a protruded coupling portion 421 having a smaller outside diameter than the hole 583 in the holder 58 protrudes to the other side L3b in the third direction L3. In the center of the third holder 43, a protruded coupling portion 431 having a smaller outside diameter than the hole 583 of the holder 58 protrudes to the other side L3b in the third direction L3 and a protruded joint portion 432 having a smaller outside diameter than the hole 583 in the holder 58 protrudes to one side L3a in the third direction L3. The protruded coupling portion 431 in the third holder 43 is in contact with the protruded coupling portion 411 of the first holder 41 inside the hole 583 of the holder 58. The protruded joint portion 432 in the third holder 43 is in contact with the protruded coupling portion 421 of the second holder 42 inside the hole 583 of the holder 58. At the tip end portions of the protruded coupling portions in the third holder 43, positioning protrusion portions 433 and 434 are respectively formed; at the tip end portions of the protruded coupling portions 411 and 421, recess portions 413 and 423 are respectively formed for the protruded portions 433 and 434 to fit into. Also, the protruded coupling portion 431 in the third holder 43 is coupled with the protruded coupling portion 411 in the first holder 41 by an adhesive, etc.; the protruded coupling portion 432 in the third holder 43 is coupled with the protruded coupling portion 421 in the second holder 42 by an adhesive, etc. Therefore, the first holder 41, the second holder 42 and the third holder 43 are connected to each other at a body portion, which consists of the protruded coupling portions 411, 431, 432 and 421, inside the hole 583 of the holder 58.

Consequently, a wall portion 584 on the inside of the hole 583 of the holder 58 which is provided to the support body 5 surrounds the circumferential surface of the body portion 40 provided to the movable body 4 to configure a stopper mechanism 50 which restricts the movable range of the movable body 4 in the direction perpendicular to the third direction L3.

(Operation at First Vibration Generating Device 1a)

In the first vibration generating device 1a, the first coils 12 of the first magnetic drive circuit 10 are electrified with alternating current to linearly vibrate the movable body 4 in the third direction L1. The second coils 22 of the second magnetic drive circuit 20 are electrified with alternating current to linearly vibrate the movable body 4 in the second direction L2. At that time, the center of gravity in the first vibration generating device 1a shifts in the first direction L1 and in the second direction L2; therefore, the pen-type haptic force delivery device 100, which is described referring to FIG. 1, vibrates with the directionality in the first direction L1 and in the second direction L2. Therefore, a user can perceive the vibrations in the first direction L1 and the vibrations in the second direction L2 as haptic force with directionality. Also, if the alternate current waveform applied to the first coils 12 is adjusted to differentiate the speed at which the movable body 4 moves toward one side in the first direction L1 from the speed at which the movable body 4 moves toward the other side in the first direction, a user can perceive the vibrations having a directionality of either side in the first direction L1. In the same manner, if the alternate current waveform applied to the second coils 22 is adjusted to differentiate the speed of the movable body 4 moving toward one side in the second direction L2 from its speed moving toward the other side in the second direction L2, a user can perceive the vibrations having a directionality of either side in the second direction L2.

In the first magnetic drive circuit 10 and the second magnetic drive circuit 20, the first coils 12 and the first magnets 11 are opposed to each other in the third direction L3, and the second coils 22 and the second magnets 21 are opposed to each other in the third direction L3. Therefore, even if both the first magnetic drive circuit 10 and the second magnetic dive circuit 20 are provided, the dimension of the first vibration generating device 1a in the third direction L3 can be kept relatively small. For this reason, in the first magnetic drive circuit 10 and the second magnetic drive circuit 20, the first coils 12 and the second coils 22 are arranged in two layers in the third direction L3 and the first magnets 11 and the second magnets 21 are arranged at both sides in the third direction L3 of each of the first coils 12 and the second coils 22 in each layer to increase the strength of the first magnet drive circuit 10 and the second magnet drive circuit; even in this case, the dimension of the first vibration generating device 1a in the third direction L3 can be kept relatively small. Since the first magnet 11 and the second magnet 21 are arranged at both sides in the third direction L3 of each of the first coils 12 and the second coils 22 in each layer, there is less magnetic flux leakage, compared to the case in which the magnet is opposed to only one surface of the coil. Therefore, the thrust to move the movable body 4 can be increased.

When the elastic member 7 is composed of a spring member, the movable body 4 may resonate at the frequency which corresponds to the mass of the movable body 4 and the spring constant of the spring member; however, since a viscoelastic body is used for the elastic member 7 in this embodiment, the resonance of the movable body 4 can be restrained. Also, the viscoelastic body is fixed to both the movable body 4 and the support body 5 by a method of adhesive or the like. Therefore, the viscoelastic body is prevented from moving with the movable body 4. Therefore, since only a viscoelastic body can be used for the elastic member 7, the configuration of the first vibration generating device 1a can be simplified. The viscoelastic body used for the elastic member 7 deforms in the direction (the sheering direction) intersecting perpendicularly with the thickness direction when the movable body 4 moves in the first direction L1 and in the second direction L2. The deformation characteristics of the viscoelastic body in the sheering direction demonstrate more linear components than nonlinear components. Therefore, the vibration characteristics with excellent linearity can be obtained in the driving directions (the first direction L1 and the second direction L2) of the first vibration generating device 1a.

[Configuration of Second Vibration Generating Device 1b]

### (Overall Configuration of Second Vibration Generating Device 1b)

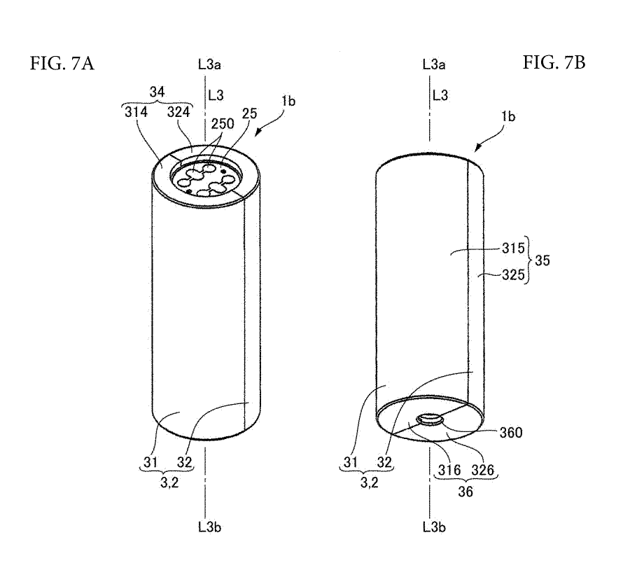

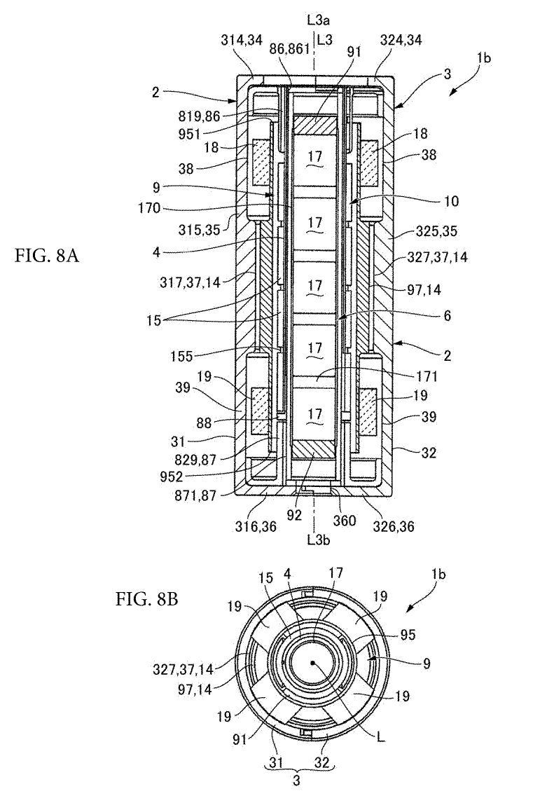

FIG. 7 is perspective views of a second vibration generating device 1b used in the pen-type haptic force delivery device 100 to which at least an embodiment of the present invention is applied: FIGS. 7A and 7B respectively show a perspective view of the second vibration generating device 1b observed from one side L3a in the third direction and a perspective view of the second vibration generating device 1b observed from the other side L3b in the third direction. FIG. 8 is cross-sectional views of the second vibration generating device 1b shown in FIG. 7: FIGS. 8A and 8B are respectively a cross-sectional view of the second vibration generating device 1b taken along the third direction L3 and a cross-sectional view taken along the plane orthogonally intersecting with the third direction L3.

As shown in FIG. 7 and FIG. 8, the second vibration generating device 1b is in a shaft shape which extends in the third direction L3. The second vibration generating device 1b has a support body 2, which includes a cylindrical cover 3 and the like, and a movable body 6, which is supported to be movable in the third direction L3 with respect to the support body 2 inside the cover 3; the support body 2 is held by a case 110 shown in FIG. 1. As described referring to FIG. 8 through FIG. 12, in this embodiment, the support body 2 has the cover 3, a bobbin 8, and coils 15, and the movable body 6 has permanent magnets 17, a sleeve 170 and an outer yoke 9 which together with the coils 15 configure a magnetic drive circuit 60. The movable body 6 is supported by the elastic members 18 and 19 to the support body 2, but a spring member to support the movable body 6 is not used.

(Configuration of Cover 3)

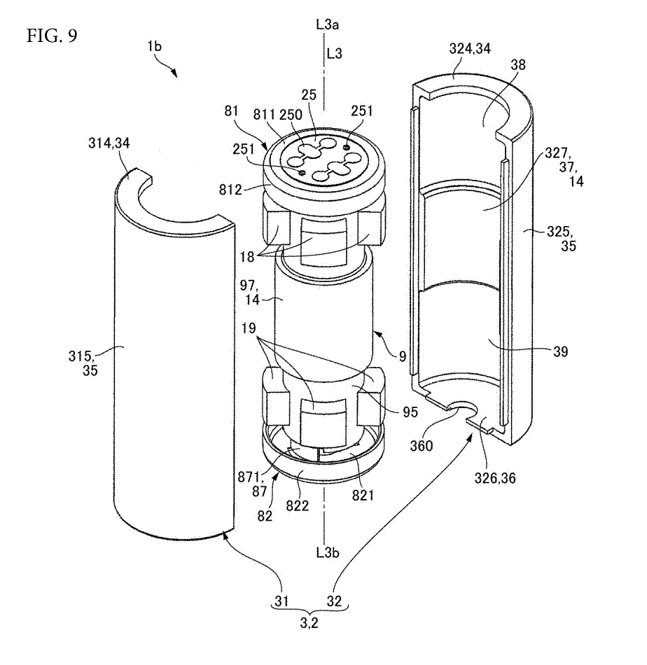

FIG. 9 is a perspective view of the exploded second vibration generating device 1b shown in FIG. 7, in which the cover 3 is removed. As shown in FIG. 7, FIG. 8 and FIG. 9, the cover 3 of the support body 2 is provided with a cylindrical body portion 35, which extends in the third direction L3, a bottom portion 36 provided on the other side L3b in the third direction of the body portion 35, and an annular portion 34 provided on one side L3a in the third direction of the body portion 35. A wiring board 35 is exposed from the inside of the annular portion 34; lands 250 on the wiring board 25 are used to supply driving signals to the coils 15 from the outside. In the center of the bottom plate portion 36, an opening portion 360 is created for emitting sound, which is described later. On the inside circumferential side of the body portion 35, a mid-point in the third direction L3 is made as a smaller diameter portion 37 which has a smaller inside diameter than the diameter of the portions at both sides in the third direction L3 and the portions at both sides in the third direction L3 are made as larger diameter portions 38 and 39 which have larger inside diameter than the smaller diameter portion 37.

The cover 3 is divided in the circumferential direction into two members (into a first cover 31 and a second cover 32); the first cover 31 and the second cover 32 are joined together to configure the cover 3. The first cover 31 and the second cover 32 respectively have side portions 315 and 325 with a semi-circular cross-section, which together configure the body portion 35, first end portions 316 and 326, which together configure the bottom portion 36, and arc-shaped second end portions 314 and 324, which together configure the annular portion 34. Inside the side portions 315 and 325, protrusion portions 317 and 327, which configure the small diameter portion 37, extend in the circumferential direction.

(Configuration of Movable Body 6)

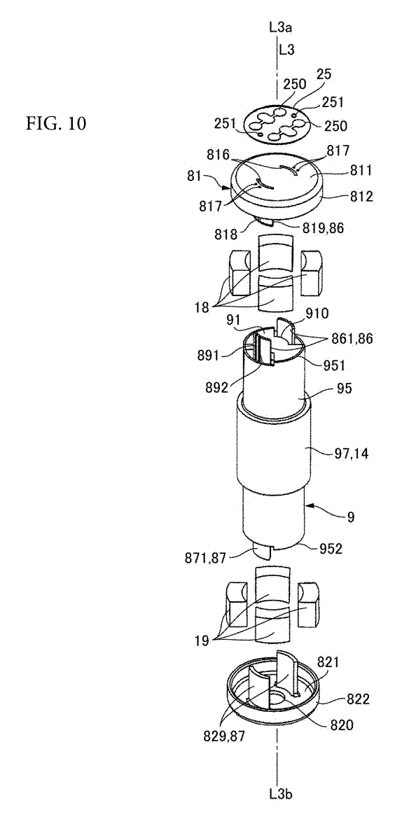

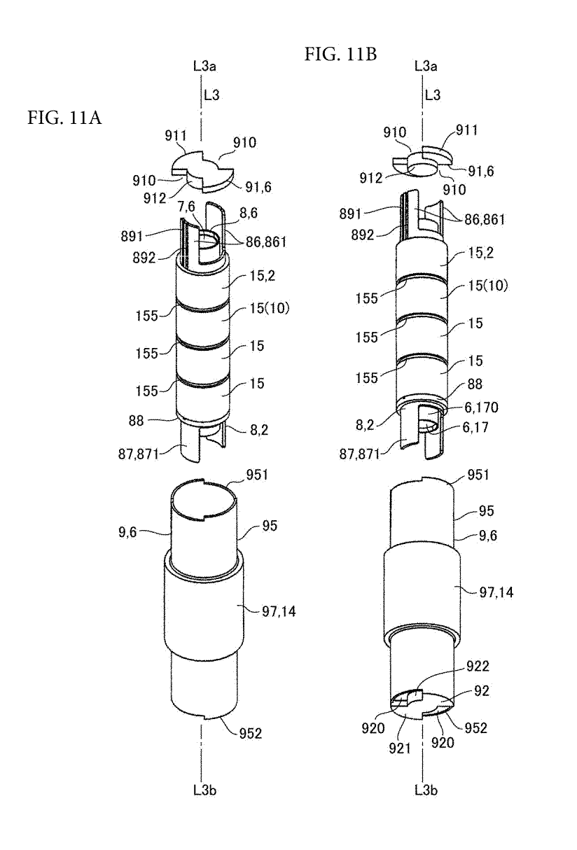

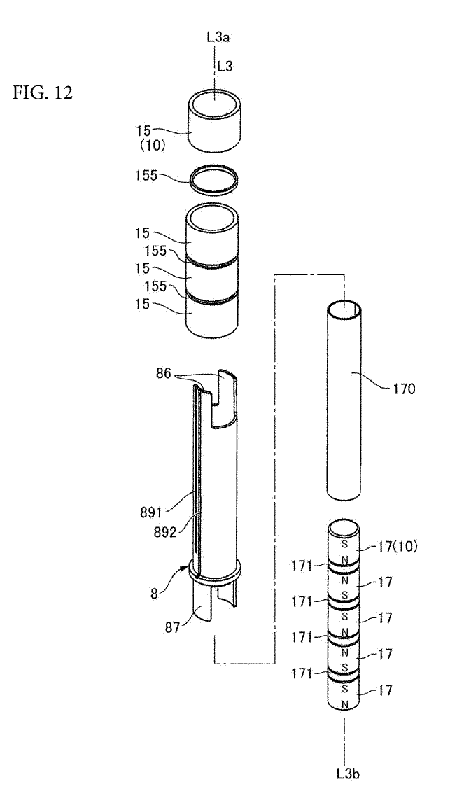

FIG. 10 is a perspective exploded view of the second vibration generating device 1b shown in FIG. 7, in which the members arranged inside the cover 3 are exploded. FIG. 11 is perspective views of the exploded second vibration generating device 1b shown in FIG. 7, in which the outer yoke 9 is removed from the outside of the coils 15: FIGS. 11A and 11B show respectively a view from one side L3a in the third direction L3 and a view from the other side L3b in the third direction L3. FIG. 12 is a perspective view of the exploded second vibration generating device 1b shown in FIG. 7, in which the permanent magnet 17, etc. are removed from the inside of the coil 15.

In the movable body 6, as shown in FIG. 8 and FIG. 12, multiple permanent magnets 17 are arranged in layers in the third direction L3. For example, in the movable body 6, three or more permanent magnets 17 are layered. In this embodiment, five permanent magnets 17 are layered in the third direction L3. The permanent magnet 17 is in a columnar shape; between two permanent magnets 17 which are next to each other in the third direction L3, a disc-like spacer 171 made from a magnetic plate is interposed.

As shown by magnetic poles N and S in FIG. 12, the multiple permanent magnets 17 are arranged in the third direction L3 such that the same poles are opposed to each other between the adjacent magnets. For example, the first and second permanent magnets 17 from one side L3a in the third direction L3 are opposed to each other with N poles having a spacer 71 interposed; the second and third permanent magnets 17 are opposed to each other with S poles having a spacer 71 interposed. Therefore, a repulsion exists between the adjacent permanent magnets 17; however, as described below referring to FIG. 8, FIG. 9, FIG. 10, FIG. 11 and FIG. 12, the multiple permanent magnets 17 are aligned in a sleeve 170 and held by a first magnetic plate 91 and a second magnetic plate 92.

First, as shown in FIG. 8, FIG. 11 and FIG. 12, the movable body 6 has a cylindrical nonmagnetic sleeve 170 which circumferentially surrounds the permanent magnets 17; the permanent magnets 17 positioned at both ends in the third direction L3 of the sleeve 170 are recessed to the inner side from both ends of the sleeve 170 in the third direction L3. The permanent magnets 17 and the sleeve 170 are fixed to each other by an adhesive (no illustration), and the spacers 171 and the sleeve 170 are also fixed to each other by an adhesive (no illustration). When a sheet is bent in a cylindrical form to surround the permanent magnets 17 and the spacers 171 which are held by a jig (no illustration), the sleeve 170 is formed and fixed to the permanent magnets 17 and the spacers 171 by an adhesive material. Therefore, the permanent magnets 17 and the spacers 171 are supported by the sleeve 170 in a highly straight line, and the coils 15 wound around the bobbin 8 are positioned outside the sleeve 170 in the radial direction to be spaced from the sleeve 170.

The movable body 6 has the first magnetic plate 91 arranged on one side L3a in the third direction of the sleeve 170, the second magnetic plate 92 arranged on the other side L3b in the third direction L3 of the sleeve 170 and the outer yoke 9 provided with a cylindrical portion 95 to surround the coils 15 from the outside in the radial direction. The cylindrical portion 95 of the outer yoke 9 is spaced from the coils 15. The first magnetic plate 91 is connected to an end portion 951 on one side L3a in the third direction of the cylindrical portion 95 of the outer yoke 9 while in contact with the permanent magnet 17 arranged at the end on one side L3a in the third direction L3. The second magnetic plate 92 is connected to an end portion 952 on the other side L3b in the third direction of the cylindrical portion 95 of the outer yoke 9 while in contact with the permanent magnet 17 arranged at the end on the other side L3b in the third direction.

The first magnetic plate 91 is provided with a first plate portion 911 connected to the end portion 951 of the cylindrical portion 95 and a first protrusion portion 912 which is protruded from the first plate portion 911 toward the inside of the sleeve 170 and makes contact with the permanent magnet 17. The second magnetic plate 92 is provided with a second plate portion 921 connected to the end portion 952 of the cylindrical portion 95 and a second protrusion portion 922 which is protruded from the second plate portion 921 toward the inside of the sleeve 170 and makes contact with the permanent magnet 17. Therefore, the permanent magnets 17 and the spacers 171 are restrained by the first magnetic plate 91 and the second magnetic plate 92 from both sides in the third direction L3. In this embodiment, the first magnetic plate 91 is welded to the cylindrical portion 95, and the outer yoke 9 is formed such that the cylindrical portion 95 and the second magnetic plate 92 are integrally formed.

The portion of the outside circumferential surface of the cylindrical portion 95 of the outer yoke 9, which opposes the small diameter portion 97 of the cover 37, is made to be a large diameter portion 97 which protrudes toward the outer side in the radial direction. The large diameter portion 97 makes contact with the small diameter portion 37 of the cover 3 when the movable body 6 moves in the direction crossing the third direction L3. Therefore, the large diameter portion 97 formed to the cylindrical portion 95 of the outer yoke 9 and the small diameter portion 37 formed to the body portion 35 of the cover 3 together configure a stopper 14 by coming into contact with each other when the movable body 6 moves in the direction crossing the third direction L3 to define the movable range of the movable body 6 in the direction perpendicularly intersecting with the third direction L3.

(Configuration of Support Body 2)

As shown in FIG. 8, FIG. 9, FIG. 10, FIG. 11 and FIG. 12, the support body 2 has a first bobbin holder 81 which is arranged on one side L3a in the third direction L3 of the first magnetic plate 91, a second bobbin holder 82 which is arranged on the other side L3b in the third direction of the second magnetic plate 92, and a cylindrical bobbin 8 which extends in the third direction L3 between the sleeve 170 and the outer yoke 9.

The first bobbin holder 81 and the first magnetic plate 91 are opposed in the third direction L3, the second bobbin holder 82 and the second magnetic plate 92 are opposed in the third direction L3, and the bobbin 8, the sleeve 17 and the outer yoke 9 are opposed to each other in the radial direction. In the support body 2, the coils 15 are wound at multiple positions in the third direction L3 around the outside circumferential surface of the bobbin 8 and are opposed to the corresponding permanent magnets 17 in the third direction L3 via the bobbin 8 and the sleeve 170. A flange portion 88 is formed to the end portion on the other side L3b in the third direction L3 of the outside circumference of the bobbin 8, and an annular spacer 155 is mounted between the adjacent coils 15 in the third direction L3.

The first bobbin holder 81 has a first circular end plate portion 811 and a cylindrical first side plate portion 812 which extends from the outer edge of the first end plate portion 811 toward the other side L3b in the third direction; the wiring board 25 is layered on the surface on one side L3a in the third direction L3 of the first end plate portion 811. In the first end plate portion 811, two arc-shaped slits 816 are formed and two through holes 817 are formed near each of the two slits 816. One of the two through holes 817 [near each slit] is aligned with the through hole 251 formed in the wiring board 25. Therefore, the end of the coil wire used for the coils 15 can be pulled to the land 250 on the wiring board 25 via the through holes 817 and 251.

In this embodiment, a first through portion 910 is formed in the first magnetic plate 91 allowing a first coupling portion 86, which connects the bobbin 8 and the first bobbin holder 81 together, to penetrate. The first through portion 910 is formed with a notch which is created to the first plate portion 911 in a fan-shape around the first protrusion portion 912 of the first magnetic plate 91. The first coupling portion 86 has two first coupling plates 861 which are protruded from the bobbin 8 toward the first bobbin holder 81 and two first supporting plates 819 which are protruded from the first bobbin holder 81 toward the bobbin 8; in this embodiment, the first coupling plates 861 and the first supporting plates 819 respectively arc-shaped in a cross-section are overlapped with each other. Each of the two first coupling plates 861 is fitted in each of the two slits 816 which are created in the first end plate portion 811 of the first bobbin holder 81. Therefore, the first bobbin holder 81 and the first coupling plates 861 can be joined together by welding or the like inside the slit 816.

The second bobbin holder 82 has a second circular end plate portion 821 and a cylindrical second side plate portion 822 which extends the outer edge of the second end plate portion 821 toward one side L3a in the third direction; in the center of the second end plate portion 821, an opening 820 is created to align with the sound-emitting opening in the cover 3.

In this embodiment, a second through portion 920 is formed allowing the second coupling portion 87, which connects the bobbin 8 with the second bobbin holder 82, to penetrate. The second through portion 920 is made with a notch created to the second plate portion 921 in a fan-shape around a second protrusion portion 922 of the second magnetic plate 92. In this embodiment, the second coupling portion 87 is provided with two second coupling plates 871 which are protruded from the bobbin 8 toward the second bobbin holder 82 and two second supporting plates 829 which are protruded from the second bobbin holder 82 toward the bobbin 8; in this embodiment, the second coupling plates 871 and the second supporting plates 829 are respectively coupled to each other being overlapped in an arc cross-section.

In this embodiment, grooves 891 and 892 or 818 are cut respectively on the outside circumferential surface of the bobbin 8 [in the third direction L3] or on the outside circumferential surface of the first supporting plates 819 [in the third direction L3] to pull the end of the coil wire (no illustration), which composes the coil 15, in the third direction L3; the grooves 891 and 892 [continually] extend to the outside circumferential surface of the corresponding first coupling plates 861 [in the third direction L3]. Therefore, the end of the coil wire can be pulled to the land 250 on the wiring board 25 via the grooves 891, 892 and 818 and the through holes 817 and the through holes 251.

(Configuration of Elastic Member 18, 19)

In this embodiment, the movable body 6 is supported to be able to linearly move back and forth in the third direction L3 by elastic members 18 and 19, which are distanced in the third direction L3. The multiple elastic members 18 and 19 are positioned on one side L3a and the other side L3b in the third direction L3 of the stopper 14 between the outer yoke 9 and the body portion 35. The elastic member 18 is fixed at four positions, which are spaced at an equal angle interval in the circumferential direction, respectively on the outside circumferential surface of the cylindrical portion 95 of the outer yoke 9 and on the inside circumferential surface of the body portion 35 of the cover 3. The elastic member 19 is also fixed at four positions, which are spaced at an equal angle interval in the circumferential direction, respectively on the outside circumferential surface of the cylindrical portion 95 of the outer yoke 9 and on the inside circumferential surface of the body portion 95 of the cover 3. Here, the elastic member 18, 19 is composed of a viscoelastic body such as a silicone gel-based [member]. For example, the viscoelastic body 18, 19 is a silicone-based gel [member] with penetration of 10° to 110°. Penetration is defined by JIS-K-2227 or JIS-K-2220, where the smaller the value is the harder the material is. Viscoelasticity has characteristics of both viscosity and elasticity, which are remarkably found in a polymer substance such as a gel-based member, a plastic, a rubber, etc. Therefore, various kinds of gel-based members can be used for the viscoelastic member 18, 19. Also, the viscoelastic member 18, 19 may use various rubber materials or their modified materials such as natural rubber, diene-based rubber (such as styrene butadiene rubber, isoprene rubber or butadiene rubber), chloroprene rubber, acrylonitrile butadiene rubber, etc.) non-diene-based rubber (such as butyl rubber, ethylene propylene rubber, ethylene propylene diene rubber, urethane rubber, silicone rubber, fluororubber, etc.) or thermoplastic elastomer, etc. The viscoelastic member 18, 19 has linear or nonlinear stretch characteristics according to its stretch direction. For example, the viscoelastic member 18, 19 demonstrates the stretch characteristics in which a nonlinear component (a spring constant) is larger than a linear component (a spring constant) when pressed and compressively deformed in its thickness direction (the axial direction). On the other hand, when pulled and stretched in the thickness direction (the axial direction), it demonstrates the stretch characteristics in which a linear component (a spring constant) is larger than a nonlinear component (fa spring constant). Because of this, when pressed and compressively deformed in the thickness direction (in the axial direction) between the movable body 3 and the support body 2, the viscoelastic member 18, 19 can be prevented from being significantly deformed, preventing the gap between the movable body 3 and the support body 2 from significantly varying. On the other hand, when deformed in the direction (the sheering direction) crossing the thickness direction (the axial direction), the viscoelastic member 18, 19 demonstrates the stretch characteristics in which a linear component (a spring constant) is larger than a nonlinear component (a spring constant) since it is pulled and stretched in either direction. Therefore, the viscoelastic member 18, 19 has a spring force which is constant in either motion direction. For this reason, the spring element in the sheering direction of the viscoelastic member 18, 19 is used to improve reproducibility of vibration acceleration of input signals; therefore, vibrations can be actualized with delicate nuance. Note that the fixing between the elastic members 18 and 19 and the outer yoke 9 and the fixing between the elastic members 18 and 19 and the cover 3 are done using viscosity of an adhesive agent, a viscous agent or a silicone gel.

(Operation at Second Vibration Generating Device 1b)

When electricity is supplied to the coils 15 via the wiring board 25 in the second vibration generating device 1b of this embodiment, the movable body 6 is moved linearly in the third direction L3 by the magnetic drive circuit 60 configured by the coils 15 and the permanent magnets 17. At that time, the center of gravity in the second vibration generating device 1b moves linearly in the third direction L3; therefore, the pen-type haptic force delivery device 100 which has been described referring to FIG. 1 vibrates linearly with the directionality in the third direction L3. Therefore, a user can perceive the linear vibrations with the directionality in the third direction as a haptic force. Also, if the alternate current waveform applied to the coils 15 is adjusted to differentiate the speed of the movable body 6 to move to one side in the third direction L3 from the speed of the movable body 6 to move to the other side in the third direction L3, a user can perceive the linear vibrations having the directionality to either side in the third direction L3 from the pen-type haptic force delivery device 100 which has been described referring to FIG. 1.

Since the movable body 6 is configured such that the multiple permanent magnets 17 are arranged in layers in the third direction L3 and the permanent magnets 17 are arranged with the same poles opposing each other adjacently in the third direction L3, the magnetic flux of a high density is released between the adjacent permanent magnets 17. Therefore, since the number of the permanent magnets 17 can be reduced even in the case where thrust is increased, the dimension of the movable body 6 in the third direction L3 can be kept from increasing. Also, in the movable body 6, the permanent magnets 17 are enclosed by the sleeve 170; therefore, the straightness of the layered body of the multiple permanent magnets 17 in the direction along the third direction L3 can be ensured by using the sleeve 170, and also a repelling force exerting between the adjacent permanent magnets 17 in the third direction L3 can be restrained by the first magnetic plate 91 and the second magnetic plate 92.

The elastic members 18 and 19 for preventing resonance of the movable body 6 are arranged at multiple locations which are distanced in the third direction L3; therefore, even if the dimension of the movable body 6 in the third direction L3 is large, the movable body 6 can properly be supported by the elastic members 18 and 19 without using a spring member. Further, in the movable body 6, three or more permanent magnets 17 are layered; therefore, thrust can be increased and fewer permanent magnets 17 are needed even in this case. Also, the elastic members 18 and 19 are respectively arranged to oppose the support body 2 and the movable body 6 in the radial direction; therefore, when the movable body 6 vibrates in the third direction L3, [the elastic members] are deformed in its sheering direction to prevent resonance. For this reason, even if the gap at the portions of the support body 2 and the movable body 6 which oppose in the radial direction changes, there is only small change in the elastic modulus of the elastic member 18, 19; therefore, resonance produced when the movable body 6 vibrates in the third direction L3 can effectively be prevented.

At that time, in the second vibration generating device 1b, a pressure change, which happens following the vibrations of the movable body 6 in the third direction L3 is emitted as an audible sound from the opening portion 360 of the cover 3; this sound is emitted from the sound-emitting hole 116 in the case 110 of the pen-type haptic force delivery device 100 illustrated in FIG. 1.

(Major Effects of this Embodiment)

As described above, at the first vibration generating device 1a in the pen-type haptic force delivery device 100 of this embodiment, the movable body 6 is caused to vibrate linearly by the first magnetic drive circuit 10 and the second magnetic drive circuit 20 and haptic force information is output to a user. At the second vibration generating device 1b, the movable body 6 supported by the support body 5 via the elastic members 18 and 19 is caused to vibrate linearly by the magnetic drive circuit 60 and haptic force information is output to a user. For this reason, the vibrations having a directionality (the haptic force information) can efficiently be generated in the pen-type haptic force delivery device 100 in a relatively simple configuration; therefore, the cost and weight of the pen-type haptic force delivery device can be reduced.

In the pen-type haptic force delivery device 100, also, the linear vibrations in the first direction L1 and in the second direction L2 generated by the first magnetic drive circuit 10 and the second magnetic drive circuit 20 of the first vibration generating device 1a are output as haptic force information, and the linear vibrations in the third direction L3 generated by the magnetic drive circuit 60 of the second vibration generating device 1b are output as haptic force information. Thus, the pen-type haptic force delivery device 100 can output as haptic force information the linear vibrations in the first direction L1, the linear vibrations in the second direction L2, the linear vibrations in the third direction L3, and the vibrations resulted from combining those linear vibrations.

In the pen-type haptic force delivery device 100, also, the pressure change that happens following the vibrations of the movable body 6 in the third direction L3 at the second vibration generating device 1b is emitted as an audible sound from the sound-emitting hole 116 in the case 110. Therefore, the information expressed by the sound emitted from the sound-emitting hole 116 can be output in addition to the haptic force information.

### OTHER EMBODIMENTS

In the above-described embodiment, only a viscoelastic body is used for the elastic members 7, 18, and 19; however, the elastic member 7, 18, 19 may use a spring or both a spring and a viscoelastic body. Also, in the above-described embodiment, both the first vibration generating device 1a and the second vibration generating device 1b are provided; however, at least an embodiment of the present invention may be applied to a configuration in which only either the first vibration generating device 1a or the second vibration generating device 1b is provided.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A pen-type haptic force delivery device that causes a user to perceive haptic force information, the device comprising:
a case comprising a shaft portion which the user holds by hand; and
a vibration generating device provided inside of said case;
wherein said vibration generating device comprises:
a movable body,
a support body,
an elastic member having either elasticity or viscoelasticity, the elastic member being arranged between said movable body and said support body, and
a magnetic drive circuit structured to cause linear vibrations to said movable body to output said haptic force information.

2. The pen-type haptic force delivery device as set forth in claim 1, wherein
said vibration generating device comprises:
a first vibration generating device structured to output linear vibrations in a direction crossing an axial direction of said shaft portion as said haptic force information, or
a second vibration generating device structured to output linear vibrations in said axial direction as said haptic force information is provided.

3. The pen-type haptic force delivery device as set forth in claim 1, wherein
said vibration generating device comprises:
a first vibration generating device structured to output linear vibrations in the direction crossing an axial direction of said shaft portion as said haptic force information; and
a second vibration generating device structured to output linear vibrations in said axial direction as said haptic force information are provided.

4. The pen-type haptic force delivery device as set forth in claim 2, wherein
said vibration generating device comprises:
said first vibration generating device;
wherein said first vibration generating device is structured to output linear vibrations in a first direction crossing said axial direction as said haptic force information and also outputs linear vibrations in a second direction which crosses said axial direction and said first direction as said haptic force information.

5. The pen-type haptic force delivery device as set forth in claim 2, wherein:
said vibration generating device comprises said second vibration generating device; and
said case comprises a sound-emitting hole structured to emit pressure changes, which happen following vibrations in said axial direction of said second vibration generating device, as an audible sound.
